(19) United States
(12) Patent Application Publication
(10) Pub. No.: US 2006/0179293 A1
(43) Pub. Date: Aug. 10, 2006

(54) Method to boot computer system only to a secure network

(75) Inventors: Clint H. O'Connor, Austin, TX (US); Douglas M. Anson, Dripping Springs, TX (US)

Correspondence Address: BAKER BOTTS, LLP, 910 LOUISIANA, HOUSTON, TX, 77002-4995, US

(73) Assignee: Dell Products L.P., Round Rock, TX (US)

(21) Appl. No.: 11/053,161

(22) Filed: Feb. 7, 2005

(51) Int. Cl. G06F 15/177

(52) U.S. Cl. 713/1

(57) ABSTRACT

A method to boot a computer system only to a secured network is disclosed. In accordance with one embodiment, a method to boot a client only to a secured network, includes connecting the client to a secured network server through the secured network, wherein the secured network server functions as an access control list manager and includes an authorization table listing clients authorized to boot an operating system (OS) only if the client is connected to the secured network server. The method further includes transmitting a claim over the secured network from the client to the secured network server such that the client requests authorization to boot. The method further includes validating at the secured network server the claim against the authorization table. The method further includes determining whether the response denies or permits the client authorization to boot the OS.

### TECHNICAL FIELD

The present disclosure relates generally to information handling systems and, more particularly, to a method to boot a computer system only to a secure network.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems, including computer systems, typically may contain sensitive information stored within the system. Due to the nature of this information, the system may need to be secured to a particular location or individual network such that the system cannot boot unless connected to the specific individual network. For example, if the system is removed from the individual network and moved to a new location, the system would not be able to boot the operating system (OS).

Previous attempts to secure these security-sensitive systems have employed methods that prevent the system from booting the operating system unless a password such as a basic input/output system (BIOS) password or a hard disk drive (HDD) password is entered. Unfortunately, if the user knows the password(s), the system can still be booted at a different location or on a different network that may not be secured.

Other attempts to secure the system include using MAC addresses as an access control list for authorizing the system to boot the OS. The MAC address is generally particular to the boot server for a specific network. Thus, the system may still be able to boot the OS using another network boot server.

### SUMMARY

In accordance with one embodiment of the present disclosure, a method to boot a client only to a secured network including connecting the client to a secured network server through the secured network, wherein the secured network server functions as an access control list manager and includes an authorization table listing clients authorized to boot an operating system (OS) only if the client is connected to the secured network server. The method further including transmitting a claim over the secured network from the client to the secured network server such that the client requests authorization to boot. The method further including validating at the secured network server the claim against the authorization table. The method further including determining whether the response denies or permits the client authorization to boot the OS, if the client receives a response from the secured network server.

In a further embodiment, an information handling system includes a processor coupled to a processor bus and a memory coupled to the processor bus. The memory communicatively coupled with the processor. The processor able to execute instructions for booting the information handling system to a server using a secure network. The instructions including instructions for connecting to the server via the secured network, wherein the server functions as an access control list manager and includes an authorization table listing systems authorized to boot an operating system (OS) only if the information handling system is connected to the server. The instructions further including instructions for transmitting a claim over the secured network from the client to the secured network server such that the client requests authorization to boot. The instructions further including instructions for determining whether the response denies or permits the client authorization to boot the OS. The instructions further including, based on the response permitting authorization, instructions for booting the OS on the information handling system.

In accordance with a further embodiment of the present disclosure, a computer-readable medium having computer-executable instructions for a method to boot a client only to a secured network including instructions for connecting the client to a secured network server through the secured network, wherein the secured network server functions as an access control list manager and includes an authorization table listing clients authorized to boot an operating system (OS) only if the client is connected to the secured network server. The computer-readable medium further including instructions for transmitting a claim over the secured network from the client to the secured network server such that the client requests authorization to boot. The computer-readable medium further including instructions for validating at the secured network server the claim against the authorization table. The computer-readable medium further including instructions for determining whether the response denies or permits the client authorization to boot the OS, if the client receives a response from the secured network server.

One technical advantage of the present disclosure is the ability to perform a deployment of an operating system in one seamless step. In one embodiment of the present disclosure, a

Another technical advantage of some embodiments of the present disclosure is a method that prevents the information handling system from booting the operating system outside of the secured network and secures the contents of the hard disk drive (HDD) from being examined outside of the secured network. Because the system seeks authorization to boot from the server on the secured network, the system must be first connect to the server via the secured network. In some embodiments, the HDD is secured and requires the use of a password to gain access to the contents of the HDD. Thus, the use of the method prevents the system from booting outside of the secured network and further prevents access to the contents of the HDD unless the HDD password is provided.

A further technical advantage of some embodiments of the present disclosure are the ability to ensure the system remains connected to the secured network. Because the method performs periodic monitoring or checks of clients (or information handling systems) that are connected to the secured network, any system that is removed from the secured network will halt the operating system and shut down. By using periodic monitoring, each system must remain coupled to the secured network in order to stay operating. Therefore, even if the system is booted only if connected to the server via the secured network, the system must remain connected in order to stay operating and functional.

Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram showing an information handling system, according to teachings of the present disclosure;

FIG. 2 is a block diagram showing a secured network including the information handling system connected to a server, according to teachings of the present disclosure; and

FIG. 3 is a flowchart for a method to boot the information handling system only to a secure network, according to teachings of the present disclosure.

### DETAILED DESCRIPTION

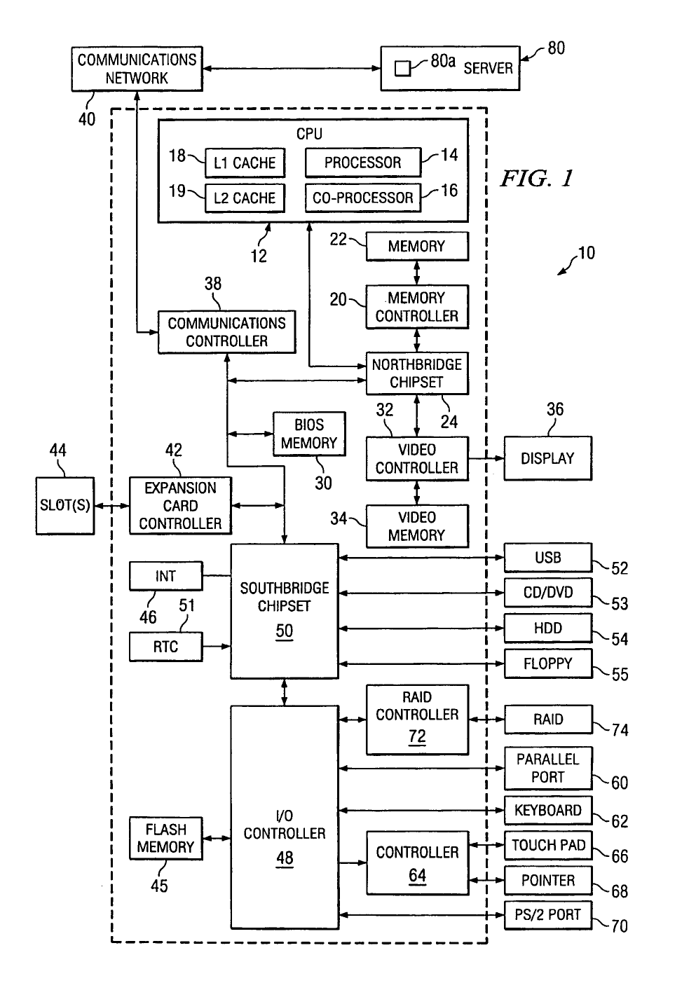

Preferred embodiments and their advantages are best understood by reference to FIGS. 1 through 3, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring first to FIG. 1, a block diagram of information handling system 10 is shown, according to teachings of the present disclosure. Information handling system 10 or computer system preferably includes one or more microprocessors such as central processing unit (CPU) 12. CPU 12 may include processor 14 for handling integer operations and coprocessor 16 for handling floating point operations. CPU 12 is preferably coupled to cache, such as L1 cache 18 and L2 cache 19 and a chipset, commonly referred to as Northbridge chipset 24, via a frontside bus 23. Northbridge chipset 24 preferably couples CPU 12 to memory 22 via memory controller 20. Main memory 22 of dynamic random access memory (DRAM) modules may be divided into one or more areas such as system management mode (SMM) memory area (not expressly shown).

Graphics controller 32 is preferably coupled to Northbridge chipset 24 and to video memory 34. Video memory 34 is preferably operable to store information to be displayed on one or more display panels 36. Display panel 36 may be an active matrix or passive matrix liquid crystal display (LCD), a cathode ray tube (CRT) display or other display technology. In selected applications, uses or instances, graphics controller 32 may also be coupled to an integrated display, such as in a portable information handling system implementation.

Northbridge chipset 24 serves as a “bridge” between CPU bus 23 and the connected buses. Generally, when going from one bus to another bus, a bridge is needed to provide the translation or redirection to the correct bus. Typically, each bus uses its own set of protocols or rules to define the transfer of data or information along the bus, commonly referred to as the bus architecture. To prevent communication problem from arising between buses, chipsets such as Northbridge chipset 24 and Southbridge chipset 50, are able to translate and coordinate the exchange of information between the various buses and/or devices that communicate through their respective bridge.

Basic input/output system (BIOS) memory 30 is also preferably coupled to PCI bus 25 connecting to Southbridge chipset 50. FLASH memory or other reprogrammable, nonvolatile memory may be used as BIOS memory 30. A BIOS program (not expressly shown) is typically stored in BIOS memory 30. The BIOS program preferably includes software which facilitates interaction with and between information handling system 10 devices such as a keyboard 62, a mouse such as touch pad 66 or pointer 68, or one or more I/O devices. BIOS memory 30 may also store system code (note expressly shown) operable to control a plurality of basic information handling system 10 operations.

Communication controller 38 is preferably provided and enables information handling system 10 to communicate with communication network 40, e.g., an Ethernet network. Communication network 40 may include a local area network (LAN), wide area network (WAN), Internet, Intranet, wireless broadband or the like. Communication controller 38 may be employed to form a network interface for communicating with other information handling systems (not expressly shown) coupled to communication network 40.

In certain information handling system embodiments, expansion card controller 42 may also be included and is preferably coupled to PCI bus 25 as shown. Expansion card controller 42 is preferably coupled to a plurality of information handling system expansion slots 44. Expansion slots 44 may be configured to receive one or more computer components such as an expansion card (e.g., modems, fax cards, communications cards, and other input/output (I/O) devices).

Southbridge chipset 50, also called bus interface controller or expansion bus controller preferably couples PCI bus 25 to an expansion bus. In one embodiment, expansion bus may be configured as an Industry Standard Architecture (“ISA”) bus. Other buses, for example, a Peripheral Component Interconnect (“PCI”) bus, may also be used.

Interrupt request generator 46 is also preferably coupled to Southbridge chipset 40. Interrupt request generator 46 is preferably operable to issue an interrupt service request over a predetermined interrupt request line in response to receipt of a request to issue interrupt instruction from CPU 12. Southbridge chipset 40 preferably interfaces to one or more universal serial bus (USB) ports 52, CD-ROM (compact disk-read only memory) or digital versatile disk (DVD) drive 53, an integrated drive electronics (IDE) hard drive device (HDD) 54 and/or a floppy disk drive (FDD) 55. In one example embodiment, Southbridge chipset 40 interfaces with HDD 54 via an IDE bus (not expressly shown). Other disk drive devices (not expressly shown) which may be interfaced to Southbridge chipset 40 include a removable hard drive, a zip drive, a CD-RW (compact disk-read/write) drive, and a CD-DVD (compact disk—digital versatile disk) drive.

Real-time clock (RTC) 51 may also be coupled to Southbridge chipset 50. Inclusion of RTC 51 permits timed events or alarms to be activated in the information handling system 10. Real-time clock 51 may be programmed to generate an alarm signal at a predetermined time as well as to perform other operations.

I/O controller 48, often referred to as a super I/O controller, is also preferably coupled to Southbridge chipset 50. I/O controller 48 preferably interfaces to one or more parallel port 60, keyboard 62, device controller 64 operable to drive and interface with touch pad 66 and/or pointer 68, and PS/2 Port 70. FLASH memory or other nonvolatile memory may be used with I/O controller 48.

RAID 74 may also couple with I/O controller using interface RAID controller 72. In other embodiments, RAID 74 may couple directly to the motherboard (not expressly shown) using a RAID-on-chip circuit (not expressly shown) formed on the motherboard.

Generally, chipsets 24 and 50 may further include decode registers to coordinate the transfer of information between CPU 12 and a respective data bus and/or device. Because the number of decode registers available to chipset 24 or 50 may be limited, chipset 24 and/or 50 may increase the number or I/O decode ranges using system management interrupts (SMI) traps.

Communications network 40 further couples or connects to server 80 over a network (shown below in more detail). Server 80 generally includes computer readable files 80a that may be used to store information or applications. For example, server 80 may include an authorization table that allows server 80 to function as an access control list manager. The manager may use the authorization table to authorize information handling system 10 to boot an operating system (OS) such that information handling system 10 only boot when connected to server 80 using the network.

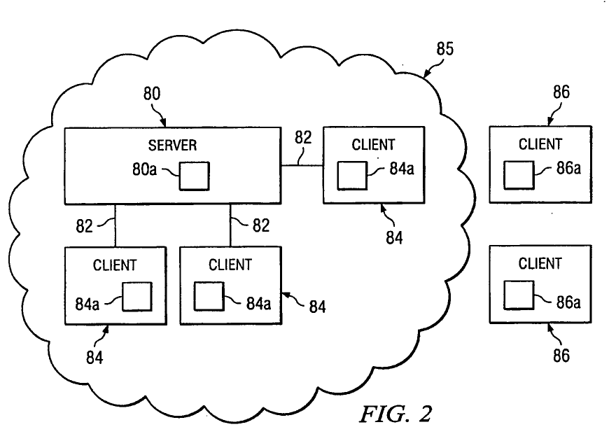

FIG. 2 is an example embodiment of the present disclosure illustrating server 80 connecting to various clients 84 through secured network bus 82 within secured network 85. Server 80 may form a part of secured network 85 such that a plurality of clients 84 connect to server 80.

Clients 84 and 86 are some examples of information handling system 10 that may connect to server 80. In some embodiments, clients 84 and 86 may include computer systems and servers that connect to server 80 through secured network 85.

Each client 84 and client 86 typically includes files 84a and 86a such as data, programs or applications. In certain embodiments, files 84a and 86a include applications that require to authorization from server 80 to boot an OS on respective client 84 or 86 only if client 84 or 86 is connected to secured network 85.

As illustrated, a plurality of clients 84 are connected to server 80 through secured network 85. As such, each client 84 may receive authorization to boot an OS, which may be included as part of files 84a. Because clients 84 were connected to server 80 through secured network 85, client 84 were authorized to boot an OS.

However, any information handling system such as client 86 that is placed or removed from secured network 85 and does not connect to server 80 does not receive the authorization to boot the OS. Therefore, clients 86 are not able to boot and any information contained within client 86 such as data or information in the hard disk drive is inaccessible and secure.

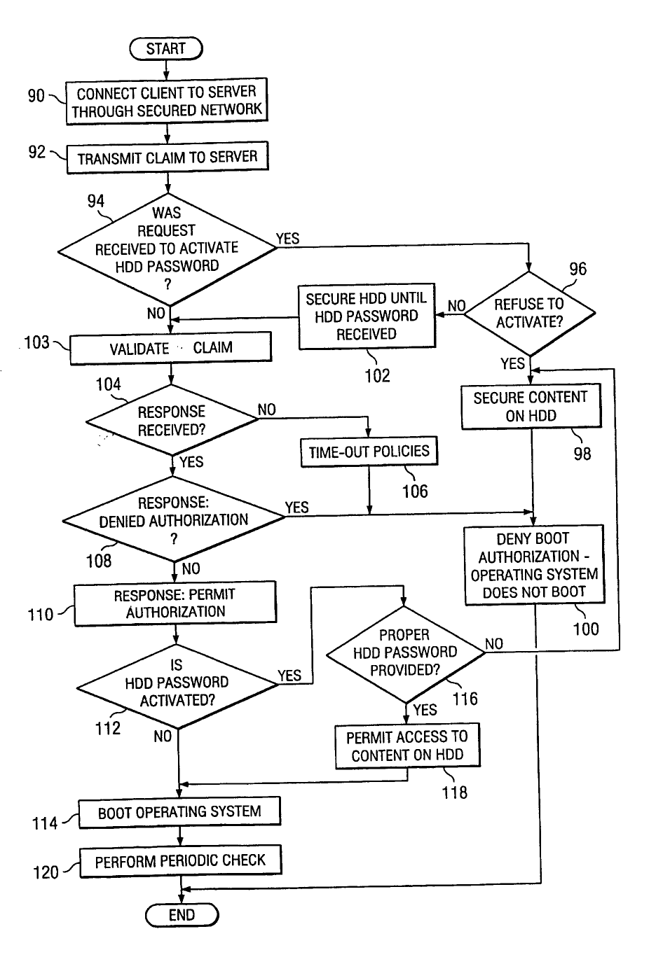

FIG. 3 is a flowchart for a method to only boot information handling system 10 if connected to a secure server through a secure network. In some embodiments, the method is stored on computer-readable medium having computer-executable instructions for performing the method.

As shown at block 90, the method connects client 84 to server 80 through secured network 85 via secured network bus 82. Generally, server 80 includes a secured network server that functions as an access control list manager and includes an authorization table that list clients authorized to boot an operating system (OS) only if the client is connected to the secured network server.

In some instances, the connection through network 85 may involve a network-level authentication such as 802.1x port authentication using client credentials for authentication onto network 85. Once connected, client 84 may be able to communicate with server 80 in order to receive authorization to boot the OS.

Once connected to server 80, client 84 attempts to boot the OS. As such, client 84 may utilize basic input/output system (BIOS) to perform instructions for attaining authorization to boot the OS. In attempting to attain authorization to boot, the BIOS of each client 84 may present or transmit a claim to server 80, as shown at block 92.

A claim includes various means of identifying each client 84. Typically, each claim is a client-specific secret that is used to identify a specific client. In some embodiments, the client is identified by using a Transaction Processing Manager serial identification (TPM serial ID), a Media Access Control (MAC) address, a BIOS string, a central processing unit (CPU) tag, a service tag, or any combination thereof. Additionally, the claim may include other arbitrary or random identifiers that are specific to one client.

In some embodiments, after the claim is transmitted, server 80 may direct or request that client 84 activate an HDD password (not expressly shown), as shown at block 94. Typically, the activation of the HDD password is controlled by BIOS 30, which usually does not store the HDD password—unlike a user-specific password.

Based on the request to activate the HDD password, client 84 using BIOS 30 may refuse or deny the request to activate the HDD password, as shown at block 96. If client 84 refuses to activate the HDD password, the HDD such as HDD 54 may become secured as to access to the content stored on HDD 54 as shown at block 98. As such, the contents of HDD 54 are secured from being examined outside of network 85 and even if removed from information handling system 10. Once secured, client 84 may be denied boot authorization such that the OS does not boot on client 84 as shown at block 100.

Typically, client 84 does not refuse activation of the HDD password. Once activated, the information on HDD 54 may become secured from access until the proper HDD password is received at client 84 as shown at block 102.

Once the claim presents to server 80, the claim can be validated or verified, as shown at block 103. The validation of the claim typically includes comparing the claim to a list of authorized claims in an authorization table. For example, if the claim was the MAC address of client 84, server 80 may compare this address against a list of authorized MAC addresses listed in an authorization table (not expressly shown).

The authorization table may be stored with server 80 or external to server 80. Typically, authorization table may be stored as part of file 80a. In some embodiments, the method allows for user intervention to manage control of the authorization tables. For example, a network-managed entity (not expressly shown) may be use to add, delete or modify the authorized clients permitted to boot the OS if connected to server 80.

After the claim is sent to server 80, client 84 waits and determines if a response is received from server 80 regarding authorization to boot the OS as shown at block 104. If server 80 does not response within a certain timeframe such as a time-out response, client 84 may consider that server 80 timed-out before a response was sent. If the server times-out, client 84 may fall back or utilize a set of time-out policies typically set in BIOS 54 as shown at block 106. Based on the time-out policies, client 84 may begin to take further steps including the possibility of re-transmitting the claim as shown at block 92. However, even if client 84 times-out, client 84 is not authorized to boot the OS. Thus, client 84 is denied authorization to boot such that the OS does not boot on client 84 as shown at block 100.

Typically, server 80 responses to client 84 based on the claim being authorized to boot the OS. If the response denies client 84 authorization to boot as shown at block 108, client 84 is denied authorization to boot such that the OS does not boot on client 84 as shown at block 100.

If, however, server 80 authorizes the claim from client 84, server 80 may generates and sends a response to respective client 84 with approval or authorization to proceed to boot the OS as shown at block 110. At block 112, the method determines whether the HDD password was activated back at block 94.

Based on the HDD password being activated, the method determines whether the proper HDD password was provided by server 80 as shown at block 116. Typically, the HDD password is sent to client 84 with the authorization response to boot the OS. However, in some embodiments, the HDD password may be sent separately by server 80 and may even be sent to client 84 as a response to an HDD password request (not expressly shown).

If the HDD password does not match, such that the HDD password is not proper, the method may cause the contents of HDD 54 to become secured, as shown at block 98. As such, client 84 cannot boot the OS until the proper HDD password is provided. Thus, the authentication of client 84 based on the claim may prevent client 84 from booting outside of network 85 and further, the use of the HDD password may secure the contents of HDD 54 from being examined outside of network 54 or even if removed from client 84.

Receiving the proper HDD password at client 84, permits access to the content of information on HDD 54 as shown at block 118. Now that both the authorization to boot the OS and the proper HDD password is supplied, client 84 boots the OS as shown at block 114.

If, back at block 112, the HDD password was not activated, client 84 may boot the OS based only on the authorization to boot the OS received from server 80.

Once the OS has booted and client is running on network 85, the method may further perform periodic monitoring or checks of client 84, as shown at block 120. Typically, the periodic monitoring can be performed through an OS-aware method or a BIOS method, which is usually performed transparent to the OS. Periodic monitoring can be periodically required and initiated by server 80 or client 84 via BIOS 54.

During the periodic monitoring, the OS is running and can be left running such that the monitoring is transparent to the OS. Monitoring proceeds to determine whether client 84 is authorized, usually in a re-authentication process. If the re-authentication process fails, the OS on client 84 may be stopped or halted such that client 84 may have to undergo the boot authorization again. Alternatively, client 84 may be rebooted by BIOS 54. Typically, the claim may be identical to the first claim that was used for the authorized to boot. However, in other embodiments, the claim may be changed to a new secret that was passed from server 80 to client 84 for the new boot session.

Although the disclosed embodiments have been described in detail, it should be understood that various changes, substitutions and alterations can be made to the embodiments without departing from their spirit and scope.

What is claimed is:

1. A method to boot a client only to a secured network, comprising:
connecting the client to a secured network server through the secured network, wherein the secured network server functions as an access control list manager and includes an authorization table listing clients authorized to boot an operating system (OS) only if the client is connected to the secured network server;
transmitting a claim over the secured network from the client to the secured network server such that the client requests authorization to boot;
validating at the secured network server the claim against the authorization table; and
if the client receives a response from the secured network server, determining whether the response denies or permits the client authorization to boot the OS.

2. The method of claim 1, further comprising, if the client does not receive a response from the secured network server, automatically causing the client to proceed according to time-out policies stored in the basic input/output system (BIOS) of the client.

3. The method of claim 1, further comprising:
during the validation of the claim, causing the BIOS to activate use of a hard disk drive (HDD) password in a HDD in the client such that the HDD password must be provided to access the HDD;
if the client does not activate the use of the HDD password, refusing to validate the claim from the client at the secured network server, thereby preventing the client from booting the OS; and
based on the activation of the use of the HDD password and the validation of the claim, sending the HDD password from the secured network server to the client, whereby sending the correct HDD password permits access to the HDD.

4. The method of claim 1, further comprising, based on the client booting the OS, monitoring the client to ensure that the client remains connected to the secured network server.

5. The method of claim 4, wherein the monitoring comprises an OS-aware method.

6. The method of claim 4, wherein the monitoring comprises a BIOS method.

7. The method of claim 4, wherein the monitoring further comprises running a transparent application to the OS booted on the client such that the client is unaware of the monitoring.

8. The method of claim 4, further comprising performing a re-authentication process of the client such that, if the re-authorization fails, the OS halts on the client.

9. An information handling system, comprising:
a processor coupled to a processor bus;
a memory coupled to the processor bus, the memory communicatively coupled with the processor; and
the processor operable to execute instructions for booting the information handling system to a server using a secure network, the instructions comprising:
instructions for connecting to the server via the secured network, wherein the server functions as an access control list manager and includes an authorization table listing systems authorized to boot an operating system (OS) only if the information handling system is connected to the server;
instructions for transmitting a claim over the secured network from the client to the secured network server such that the client requests authorization to boot;
instructions for determining whether the response denies or permits the client authorization to boot the OS; and
based on the response permitting authorization, instructions for booting the OS on the information handling system.

10. The information handling system of claim 9, further comprising:
a basic input/output system (BIOS) operably including time-out policies, the BIOS operably coupled to the processor and memory; and
the BIOS operable to direct the information handling system to a next step if no response is received from the server.

11. The information handling system of claim 9, wherein instructions for booting further comprises monitoring the information handling system to ensure that the information handling system remains connected to the server via the secured network.

12. The information handling system of claim 9, further comprising:
a hard disk drive (HDD) operably coupled to the processor and memory;
the HDD operably including an HDD password, the HDD password secures contents of the HDD from being examined.

13. The information handling system of claim 12, wherein the instructions for booting the processor further comprising instructions for activating the HDD password to secure the contents of the HDD.

14. The information handling system of claim 9, wherein the claim comprises a client-specific identifier selected from a group of identifiers consisting of a Transaction Processing Manager serial identification (TPM serial ID), a Media Access Control (MAC) address, a BIOS string, a central processing unit (CPU) tag, a service tag, and any combination thereof.

15. The information handling system of claim 9, wherein the claim comprises a client-specific secret.

16. A computer-readable medium having computer-executable instructions for a method to boot a client only to a secured network, comprising:
instructions for connecting the client to a secured network server through the secured network, wherein the secured network server functions as an access control list manager and includes an authorization table listing clients authorized to boot an operating system (OS) only if the client is connected to the secured network server;
instructions for transmitting a claim over the secured network from the client to the secured network server such that the client requests authorization to boot;
instructions for validating at the secured network server the claim against the authorization table; and
instructions for determining whether the response denies or permits the client authorization to boot the OS, if the client receives a response from the secured network server.

17. The computer-readable medium of claim 16, further comprising:
instructions for causing the BIOS to activate use of a hard disk drive (HDD) password in a HDD in the client such that the HDD password must be provided to access the HDD during the validation of the claim;
instructions for refusing to validate the claim from the client at the secured network server if the client does not activate the use of the HDD password, thereby preventing the client from booting the OS; and
instructions for sending the HDD password from the secured network server to the client, whereby sending the correct HDD password permits access to the HDD, based on the activation of the use of the HDD password and the validation of the claim.

18. The computer-readable medium of claim 16, further comprising instructions for monitoring the client to ensure that the client remains connected to the secured network server, based on the client booting the OS.

19. The computer-readable medium of claim 18, further comprising instructions for performing a re-authentication process of the client such that, if the re-authorization fails, the OS halts on the client.

20. The computer-readable medium of claim 16, further comprising instructions for automatically causing the client to proceed according to time-out policies stored in the basic input/output system (BIOS) of the client, if the client does not receive a response from the secured network server.
